(19) United States
(12) Patent Application Publication
(10) Pub. No.: US 2007/0164532 A1
(43) Pub. Date: Jul. 19, 2007

(54) Bicycle skateboard rack

(75) Inventors: Sean Nemec, Spokane Valley, WA (US); Ron Stokes, Spokane Valley, WA (US)

Correspondence Address: WELLS ST. JOHN P.S., 601 W. FIRST AVENUE, SUITE 1300, SPOKANE, WA, 99201, US

(73) Assignee: SEAN NEMEC

(21) Appl. No.: 11/331,736

(22) Filed: Jan. 13, 2006

(51) Int. Cl. B62J 7/00

(52) U.S. Cl. 280/202

(57) ABSTRACT

An apparatus is provided for carrying a board on a vehicle, such as a bicycle. The apparatus includes a board rack that is carried by a frame of a vehicle, such as a frame fork on a bicycle. The board is carried in a vertical receiver of the board rack and at least one mounting bracket is carried by a frame of the board rack for affixing the frame onto a bicycle fork. In one case, the frame has a vertical receiver along a bottom end for receiving a bottom end of a board and a quick release retainer along a top end for further securing the board onto the frame. In one case, an upper mount is used to affix the frame with a releasable clamp to secure the frame to a bicycle frame fork. Additionally, a lower mount is provided for affixing the frame beneath the upper mount using an aperture that is configured to be affixed onto a wheel axel on a bicycle frame fork with a quick release wheel lock assembly.

### TECHNICAL FIELD

This invention pertains to vehicle racks for carrying articles. More particularly, the present invention relates to a bicycle board rack for carrying a board on a bicycle, such as a skateboard, a snowboard, a wakeboard, a skim board, or a surfboard.

### BACKGROUND OF THE INVENTION

FIG. 1 illustrates a prior art skateboard carrying apparatus 12 for carrying a skateboard 14 on a handlebar 16 of a bicycle 10. More particularly, skateboard carrying apparatus 12 is rigidly affixed onto a substantially horizontal cross member, or tube 18 for handlebar 16 via a clamp assembly 20. Skateboard 14 is supported along a side edge in a horizontal configuration via a wire frame 22 with a side-by-side set of u-shaped frame members 24 and 26. A bungee (or elastic) cord 30 is provided through an aperture 28 of wire frame 22. Free ends of cord 30 wrap about a board 32 of skateboard 14 and connect to each frame 24 and 26. In this configuration, board 32 of skateboard 14 is provided in a least desirable aerodynamic configuration (or maximum drag configuration) relative to bicycle 10 and handlebars 16.

Wind drag generated by board 32 while riding bicycle 10 is undesirable. First, it can lead to instability of handlebar 16 relative to a remaining frame portion of bicycle 10 which becomes a user safety concern. Secondly, it can increase the energy required to pedal bicycle 10. Furthermore, such concerns are compounded by the manner in which board 32 is supported between frames 24 and 26. Since frames 24 and 26 are relatively close together, there is a risk that board 32 can shift horizontally to one side or the other relative to frames 24 and 26. In the event board 32 shifts to one side, the aerodynamic drag exerted on board 32 and against handlebar 16 becomes unbalanced relative to a center pivot axis for handlebar 16. At increased travel speeds for bicycle 10, such imbalanced aerodynamic forces might lead to a loss of control of handlebar 16, particularly following a sudden dislodgement and horizontal shifting of board 32 relative to frames 24 and 26 of apparatus 12.

Furthermore, remaining prior art techniques require a bicycle rider to hand-carry a skateboard, or to tuck the skateboard under their arm while riding a bicycle. Such techniques can prove hazardous as they can result in the rider having a reduced ability to steer and control the bicycle.

Accordingly, improvements are needed in the manner in which a board can be transported on a vehicle, such as a bicycle.

### SUMMARY OF THE INVENTION

An apparatus is provided for carrying a board on a vehicle, such as a bicycle. The apparatus includes a board rack that is carried by a frame of a vehicle, such as a frame fork on a bicycle. The board is carried in a vertical receiver of the board rack and at least one mounting bracket is carried by a frame of the board rack for affixing the frame onto a bicycle fork. In one case, the frame has a vertical receiver along a bottom end for receiving a bottom end of a board and a quick release retainer along a top end for further securing the board onto the frame. In one case, an upper mount is used to affix the frame with a releasable clamp to secure the frame to a bicycle frame fork. Additionally, a lower mount is provided for affixing the frame beneath the upper mount using an aperture that is configured to be affixed onto a wheel axel on a bicycle frame fork with a quick release wheel lock assembly.

According to one aspect, an apparatus is provided for carrying a board on a bicycle. The apparatus includes a board rack and at least one mounting bracket. The board rack is carried by the frame of the bicycle. The board rack has a vertical receiver adjacent a bottom end and a quick release retainer above the vertical receiver. The vertical receiver is configured to removably receive and support a bottom end of the board. The quick release retainer is configured to releasably retain the board to the rack. The at least one mounting bracket is carried by the frame and is configured to affix the frame onto a bicycle fork.

According to another aspect, a skateboard carrying apparatus is provided for a bicycle. The apparatus includes a skateboard rack and at least one mounting bracket. The skateboard rack has a vertical receiver adjacent a bottom end. The vertical receiver is configured to receive and support a tapering heel of a skateboard. The skateboard rack also has a quick release retainer above the vertical receiver. The vertical receiver is configured to removably receive and support a bottom end of a board. The quick release retainer is configured to releasably retain the board to the rack. The at least one mounting bracket is carried by the frame, and is configured to affix the frame onto a bicycle fork.

According to yet another aspect, a board rack is provided for a bicycle. The board rack includes a wire frame, a frame plate, an upper mount, and a lower mount. The wire frame has a vertical receiver along a bottom end and a quick release retainer along a top end. The frame plate is affixed to the wire frame. The upper mount is affixed to the frame plate having a releasable clamp for securing around a frame fork of a bicycle. The lower mount is affixed to the frame plate beneath the upper mount and has a mounting plate with an aperture configured to be affixed onto a wheel axel on the frame fork with a quick release wheel lock assembly.

### BRIEF DESCRIPTION OF THE DRAWINGS

Preferred embodiments of the invention are described below with reference to the following accompanying drawings.

FIG. 1 is a simplified partial perspective view of a prior art skateboard rack configured to mount a skateboard in a horizontally configuration onto a handlebar member of a bicycle.

FIG. 2 is a vertical, left-side view of a skateboard affixed onto a skateboard rack that is mounted onto a left side fork tube of a bicycle, according to one aspect of the invention.

FIG. 3 is a vertical right-side view of the skateboard, skateboard rack, and bicycle of FIG. 2.

FIG. 4 is an enlarged perspective view of the skateboard rack of FIGS. 2-3 taken left of center prior to assembly onto a bicycle fork tube.

FIG. 5 is an enlarged perspective view of the skateboard rack of FIG. 4 taken right of center.

FIG. 6 is a vertical left side view of the skateboard rack of FIGS. 2-5.

FIG. 7 is a bottom end view of the skateboard rack of FIG. 6.

FIG. 8 is a right side view of the skateboard rack of FIG. 6.

FIG. 9 is a vertical right side view of the skateboard rack of FIG. 6.

FIG. 10 is a perspective component view of a frame plate of the skateboard rack of FIGS. 2-9.

FIG. 11 is a perspective component view of a wire rack of the skateboard rack of FIGS. 2-9.

FIG. 12 is a perspective component assembly view of the frame plate of FIG. 10 assembled together onto the wire rack of FIG. 11 to form a rack assembly.

FIG. 13 is a perspective component view of an alternative rack assembly over that shown in FIG. 12 having an alternatively constructed frame plate of diamond plate.

FIG. 14 is a vertical side view of the rack assembly of FIG. 12.

FIG. 15 is a bottom view of the rack assembly of FIG. 14.

FIG. 16 is a vertical component view of a mounting plate for the quick release retainer of the skateboard rack of FIGS. 2-9.

FIG. 17 is a vertical component view of a mounting plate for the vertical receiver of the skateboard rack of FIGS. 2-9.

FIG. 18 is a vertical component view from behind, taken at a right angle from above relative to the view depicted in FIG. 19, of a mounting collar for the quick release retainer of the skateboard rack of FIGS. 2-9.

FIG. 19 is a plan view of the mounting collar of FIG. 18.

FIG. 20 is a vertical component view from in front of the mounting collar of FIGS. 18-19.

FIG. 21 is a perspective component view of the mounting collar of FIGS. 18-20 prior to assembly.

FIG. 22 is a perspective component view of a rubber sleeve that is assembled onto the mounting collar of FIGS. 18-21.

FIG. 23 is a left end view of the sleeve of FIG. 22.

FIG. 24 is a face view, taken at a right angle from the right relative to the view of FIG. 23, of the sleeve.

FIG. 25 is an exploded perspective view of a fastener used to assemble together and mount the skateboard rack of FIGS. 2-9 and 27 onto a bicycle fork.

FIG. 26 is a perspective view of a bungee cord from the quick release retainer of FIGS. 2-9 and 27.

FIG. 27 is an exploded perspective view of the skateboard rack of FIGS. 2-9.

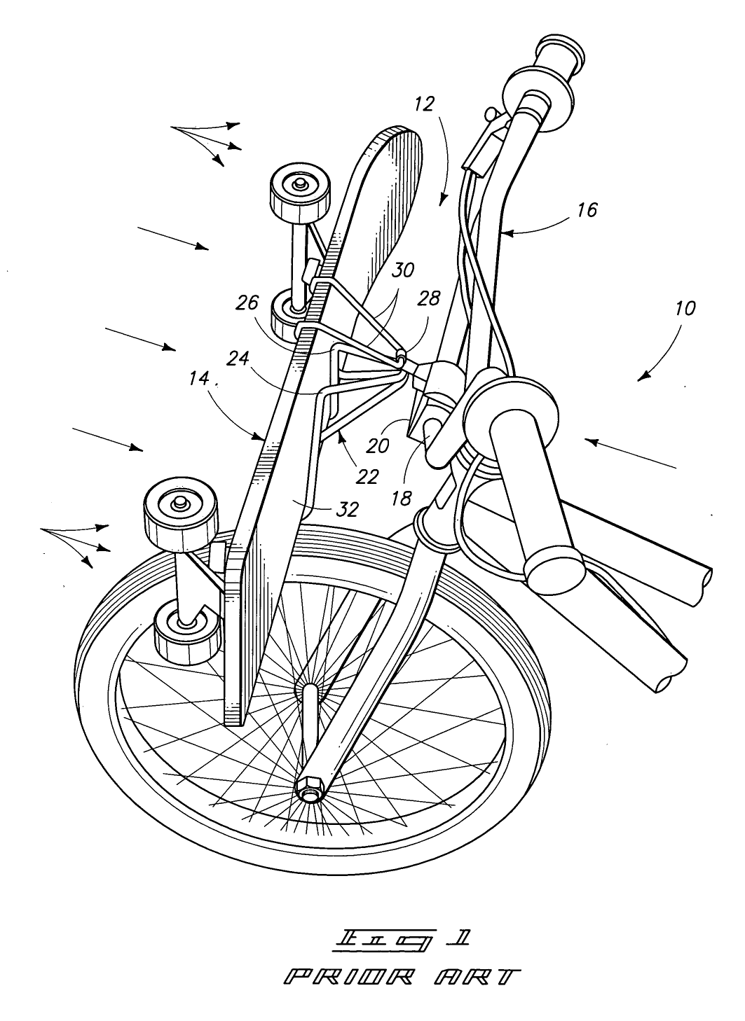

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

Reference will now be made to a preferred embodiment of Applicant's invention. More particularly, an apparatus is provided for carrying a board on a bicycle. While the invention is described by way of a preferred embodiment, it is understood that the description is not intended to limit the invention to such embodiments, but is intended to cover alternatives, equivalents, and modifications which may be broader than the embodiments, but which are included within the scope of the appended claims.

In an effort to prevent obscuring the invention at hand, only details germane to implementing the invention will be described in great detail, with presently understood peripheral details being incorporated by reference, as needed, as being presently understood in the art.

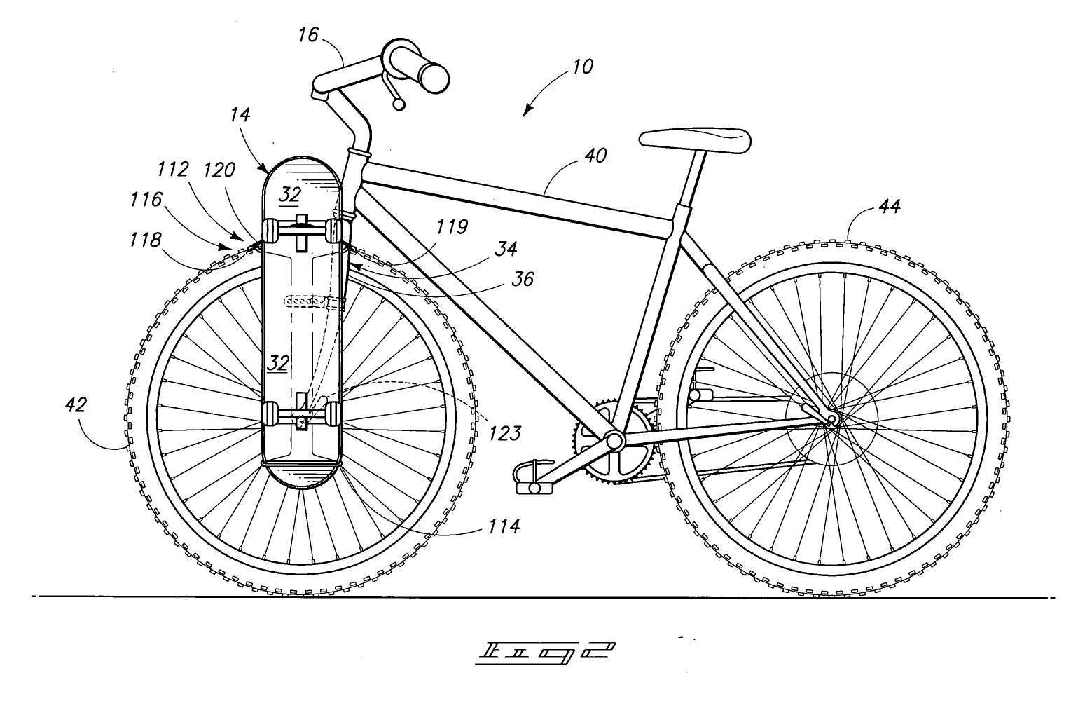

FIGS. 2 and 3 illustrate a skateboard carrying apparatus, or rack, 112 for removably mounting a skateboard 14 onto a tube 36 (see FIG. 2) of a frame fork 34 for a bicycle 10, according to the present invention. More particularly, fork 34 comprises a pair of side-by-side tubes 36 (see FIG. 2) and 38 (see FIG. 3) onto which a front wheel 42 is mounted via a wheel quick release assembly 123 (see FIG. 2). Front wheel 42 is pivotally carried on a frame 40 and is controlled for pivoting via handlebar 16 relative to back wheel 44.

A board 32 of skateboard 14 is received in a vertical configuration to be supported by apparatus 112 onto tube 36 of fork 34 such that board 32 is substantially parallel to the plane of wheel 42. Hence, board 32 is carried in an optimal, minimal wind drag configuration. As a rider turns handlebar 16 to change a direction of travel for bicycle 10, board 32 tracks the change in direction as apparatus 112 securely holds skateboard 14 via board 32 parallel to wheel 42. Accordingly, an optimal, minimal wind drag configuration for skateboard 14 is maintained, even while turning bicycle 10.

Apparatus 112 holds board 32 in the optimal, wind drag configuration by securely mounting apparatus 112 onto tube 36 (see FIG. 2) of fork 34 via a lower mount 122 and an upper mount 124, as shown in FIG. 3. A narrowing lower end of board 32 is supported in a vertical receiver 114 of apparatus 112 by lowering skateboard 14 in a downward direction to place a lower end of board 32 into vertical receiver 114. Afterwards, an upper portion of board 32 is secured onto apparatus 112 via a quick release retainer 116. As shown in FIG. 2, quick release retainer 116 comprises a pair of hooks 118 and 119 between which an elastic cord, or bungee cord 120 is stretched and connected to tightly secure board 32 onto apparatus 112.

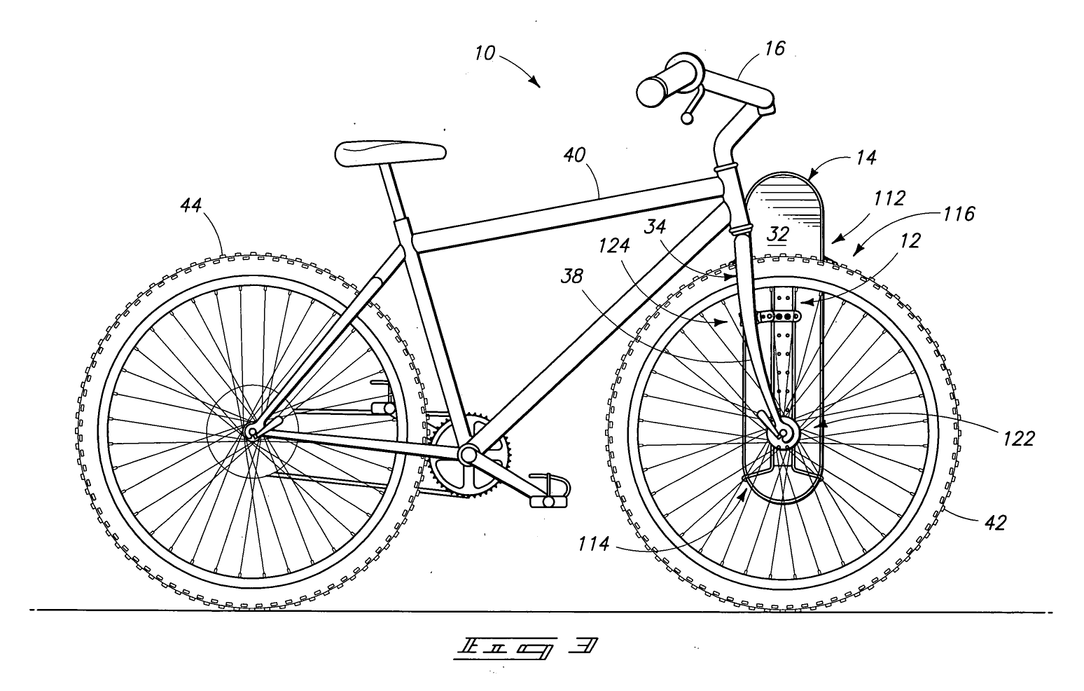

FIGS. 4-9 illustrate skateboard 14 mounted securely onto skateboard carrying apparatus 112 while apparatus 112 is removed from a bicycle. More particularly, board 32 is first lowered downwardly until a tapering back heel 142 of board 32 seats snuggly into a slot-shaped hoop 154 (see FIGS. 4-5) of vertical receiver 114, as shown in FIGS. 4-6 and 8-9. Subsequently, elastic cord, or bungee, 120 that is loaded onto one of hooks 118 and 119, is subsequently stretched across a back side of board 32, and is loaded (under tension) onto another of hooks 118 and 119.

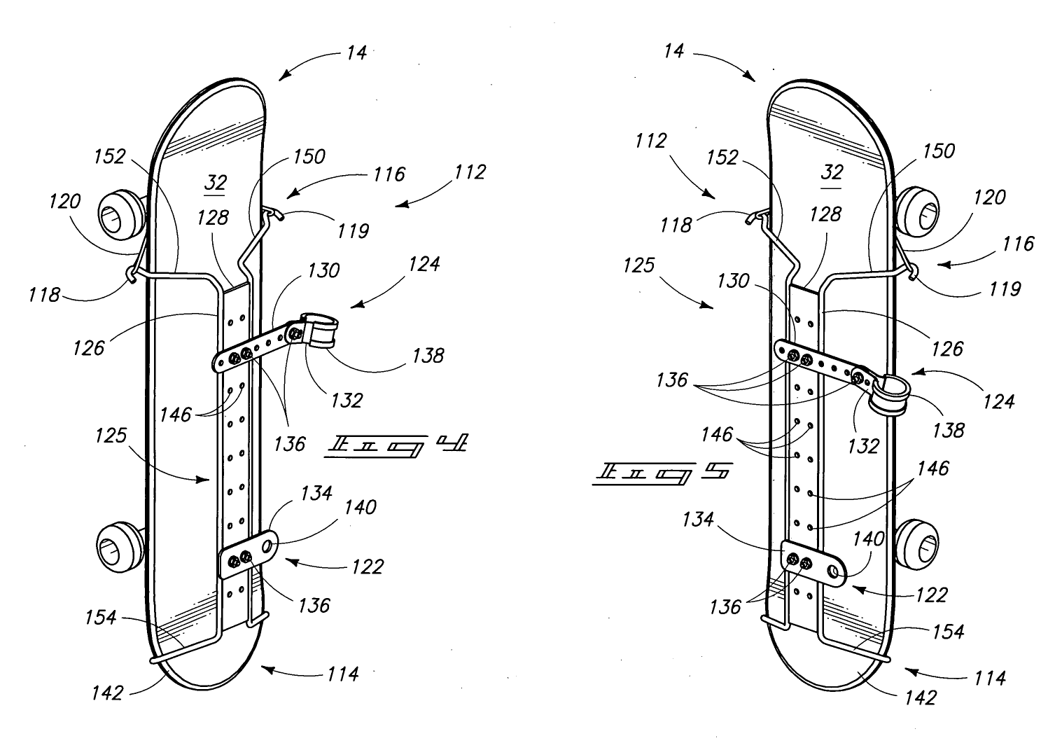

As shown in FIGS. 8-9, elastic cord, or bungee, 120 of quick release retainer 116 is stretched across and over a truck 144 of skateboard 14. When stretched, elastic cord 120 acts to downwardly retain skateboard into vertical receiver 114, as well as to also forcibly engage a front (or top) side of board 32 against a pair of arms 150 and 152 of quick release retainer 116. Arms 150 and 152 are provided by a wire cage 126 of a rack 125, as shown in FIGS. 4-9. According to one construction, wire cage 126 is welded onto a rectangular base plate, or frame 128 via a plurality of spaced-apart welds to provide rack 125 as shown in FIGS. 4-5. Hoop 154 comprises a narrow receiving slot provided along a bottom end of rack 125. In assembly, wire cage 126 and a bottom end of base plate 128 cooperate to provide hoop 154.

As shown in FIGS. 4-6, lower mount 122 and upper mount 124 can be rigidly affixed at selected locations onto base plate, or frame, 128 via a pair of fasteners 136. Fasteners 136 are received through selected pairs of apertures 146 that are spaced apart at specific vertical locations along base plate 128. In this manner, the distance between mounts 122 and 124 can be varied in order to accommodate mounting of apparatus 112 onto bicycles of various sizes, having a range of fork sizes. Furthermore, mounts 122 and 124 can both be raised or lowered in order to adjust the height at which a skateboard 14 rides in skateboard carrying apparatus 112. Optionally, apparatus 112 can be mounted onto a frame in a tilted orientation, with a board being raked forward or aft.

Lower mount 122 is formed from a flat mounting plate 134 and a pair of fasteners 136 as shown in FIGS. 4-6. Mounting plate 134 includes a pair of apertures 158 (see FIG. 17) and a larger aperture sized to receive a bicycle wheel axle bolt (not shown).

Upper mount 124 is formed from a flat mounting plate 130, fasteners 136, a clamp collar 132, and a rubber sleeve 138, as shown in FIGS. 4-9. Angular positioning of clamp collar 132 can be varied by rotating clamp collar 132 into a desired angular position relative to mounting plate 130 prior to tightening them together via a respective fastener 136. Such tightening is performed while clamp collar 132 is received around a tube of a fork on a bicycle, while aperture 140 is placed about a wheel axle bolt.

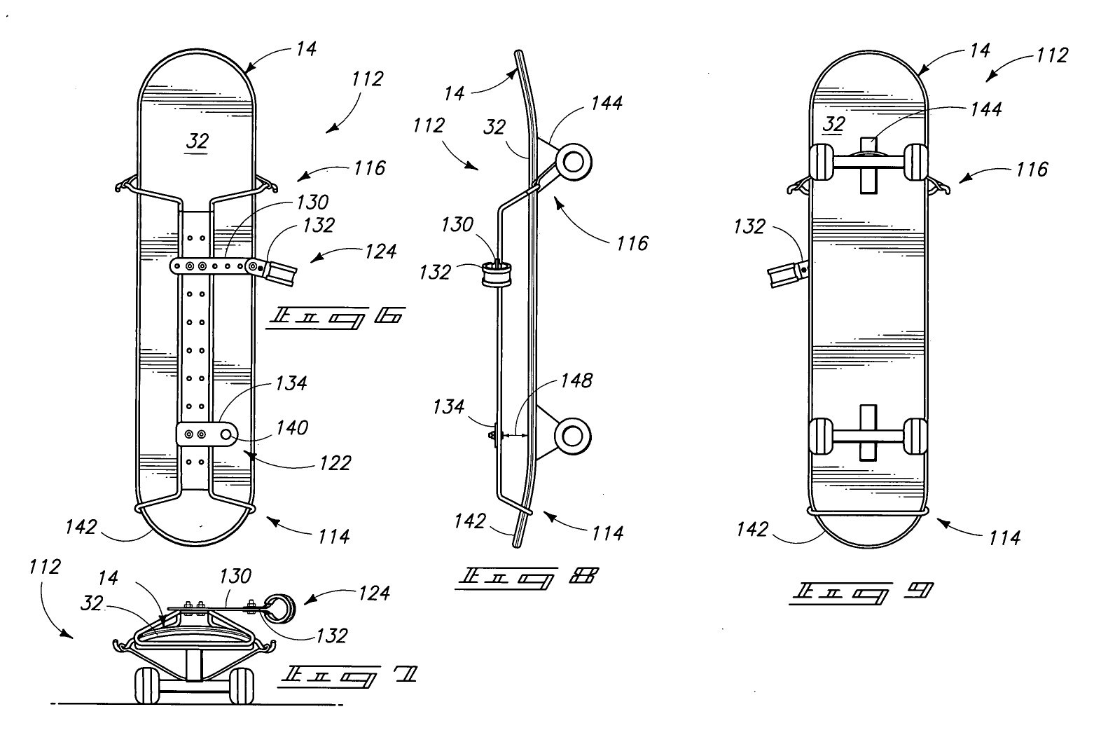

FIG. 10 shows base plate 128 prior to being affixed via welding onto wire cage 126 of FIG. 11. Base plate 128 is formed from a piece of rectangular sheet metal into which an array of apertures, or through-holes, 146 are drilled. In one case, pairs of adjacent apertures 146 are provided at a plurality of vertically spaced-apart locations along a length of base plate 128. According to one construction, base plate 128 is formed from a sheet of cold rolled steel of 17.4″, 1.75″ width, and 0.008″ thickness. Also according to one construction, pairs of adjacent apertures 146 are spaced apart horizontally 0.80″, adjacent apertures 146 are spaced apart vertically 1.75″, and apertures 146 have a diameter of 0.25″.

FIG. 11 depicts wire cage 126 prior to being welded onto base plate 128 of FIG. 10. More particularly, wire cage 126 is formed from a single piece of 0.25″ diameter wire steel rod which is bent to form a hoop 154 along a bottom end and a pair of arms 150 and 152 along a top end. Each arm 150 and 152 terminates in a hook 119 and 118 for removably receiving a loop 178 or 180 on an end of an elastic cord 120, as shown in FIG. 26.

FIG. 12 shows base plate 128 and wire cage 126 after they have been welded together along longitudinal edges of base plate 128 via a plurality of local welds (not shown). Base plate 128 and wire cage 126 cooperate in assembly to provide a board rack 125. Hoop 154 cooperates with a bottom edge of base plate 128 to provide a vertical receiver 114 (see FIG. 2) for supporting a bottom end of a board, as shown in FIGS. 2-9. A top end of base plate 128 rigidly enforces a top end of wire cage 126 to strengthen each arm 150 and 152 such that arms 150 and 152 receive a top end of a board while an elastic cord is stretched between hooks 119 and 118.

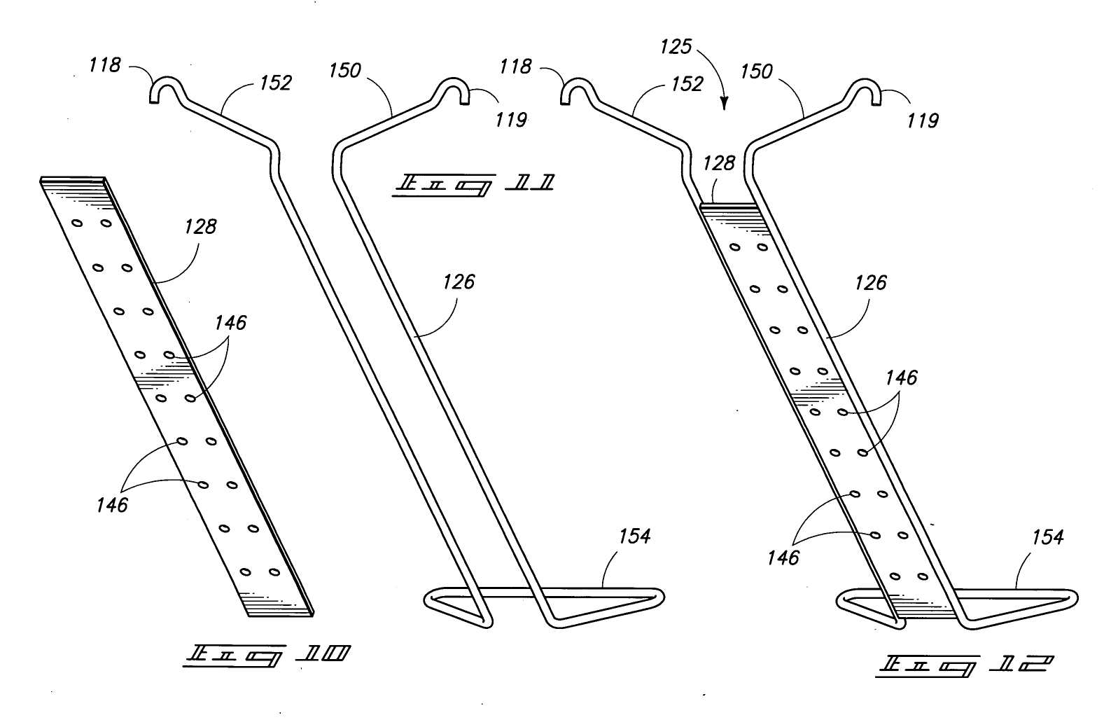

FIG. 13 illustrates an alternative construction for a board rack 1125 over the rack 125 depicted in FIG. 12 and usable in substitution for rack 125 of skateboard carrying apparatus 112 of FIGS. 2-9 and 27. More particularly, rack 1125 is formed with wire cage 126 and a base plate 1128 that is essentially the same as base plate 128 of FIGS. 10 and 12, except that base plate 1128 is formed from a sheet of diamond plated steel. Preferably, rack 1125 is plated with chrome or zinc after being assembled together via welding.

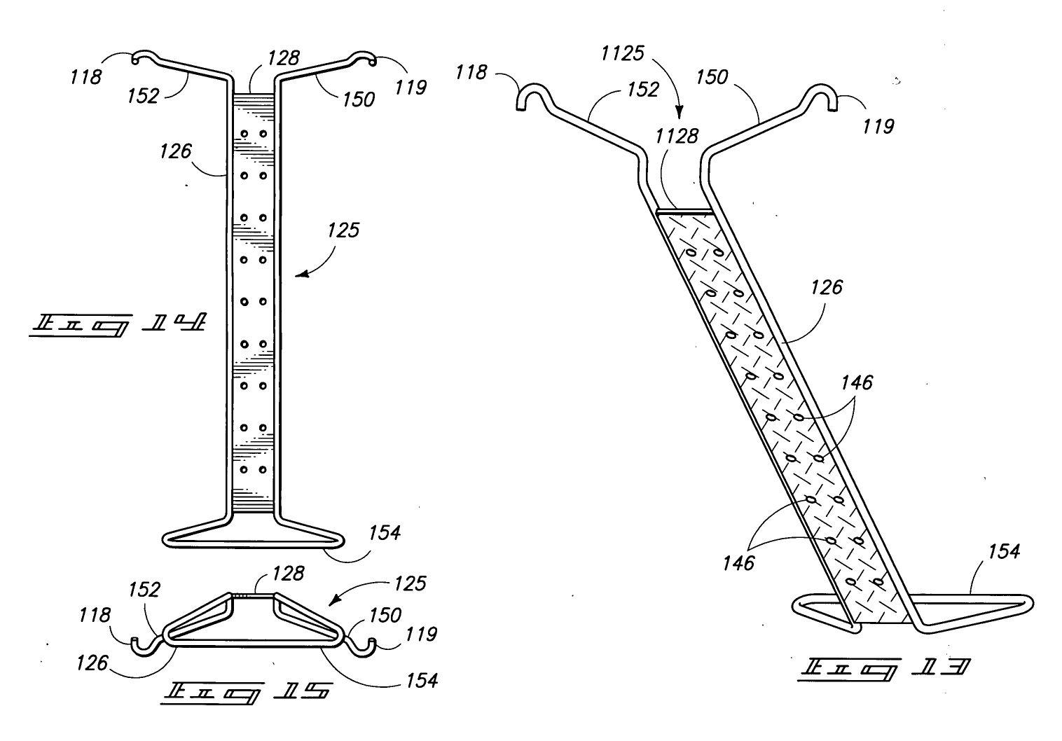

FIGS. 14 and 15 further illustrate construction of skateboard rack 125 of FIG. 12. The configuration of hoop 154, arms 150, 152, and hooks 119, 118 of wire cage 126 are shown in relation to base plate 128.

FIG. 16 illustrates the layout of seven equally spaced-apart apertures 156 in mounting plate 130. Each aperture 156 is 0.25″ in diameter. More particularly, plate 130 is formed from a sheet of 0.0150″ thick cold rolled steel that is plated with zinc or chrome.

Mounting plate 134 of FIG. 17 is formed from a sheet of 0.0150″ thick cold rolled steel plated with zinc or chrome, similar to plate 130 of FIG. 16. Plate 134 has two apertures 158 of 0.25″ diameter and a hub aperture 140 sized to receive a threaded bicycle wheel axle.

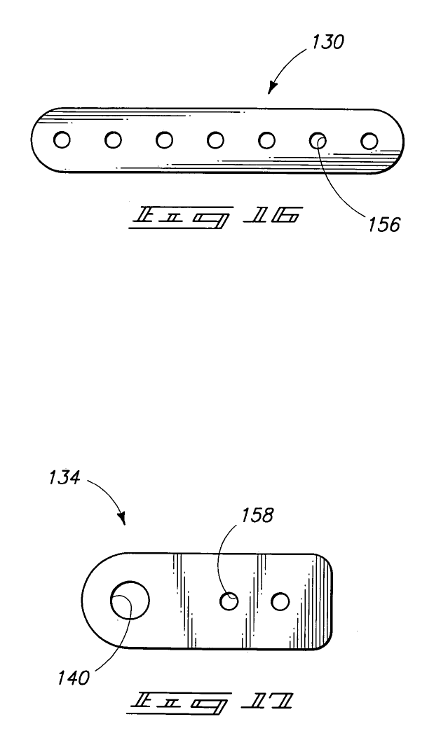

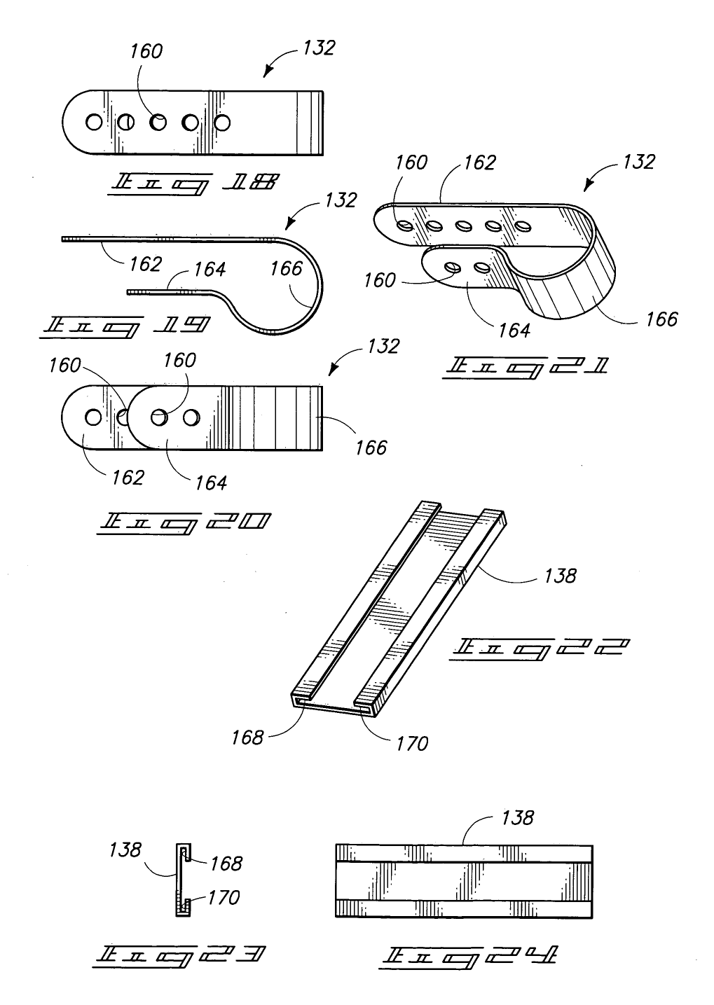

FIGS. 18-21 depict one construction for clamp collar 132 of upper mount 124 (see FIG. 27). Collar 132 has five equally spaced-apart apertures 160 along a long leg 162 and two spaced-apart apertures 160 along a short leg 164. A semi-circular band 166 is formed between legs 162 and 164. As shown in FIG. 21, collar 132 can be adjusted to clamp around a selected frame tube on a bicycle fork having one size by placing a fastener through a selected aperture 160 in each of legs 162 and 164 that will rigidly clamp band 166 around such frame tube as legs 162 and 164 are driven together when such fastener is tightened, as shown in FIG. 27 by bolt 172, washer 174, and nut 176.

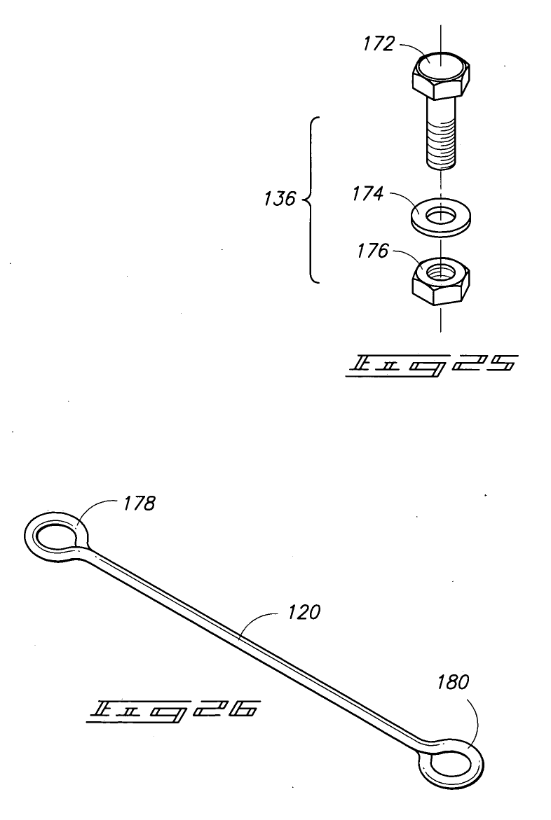

FIGS. 22-24 illustrate one construction for a rubber friction sleeve 138 that is slid over leg 162, band 166, and leg 164 to provide a friction contact surface between collar 132 and a frame tube of a bicycle fork. More particularly, sleeve 138 is formed from a synthetic rubber, urethane, or plastic that is sufficiently resilient that sleeve 138 can be slid onto collar 132. Sleeve 138 is formed with a pair of parallel, opposed edge slots 168 and 170 that are sized to snuggly receive collar 132 in assembly.

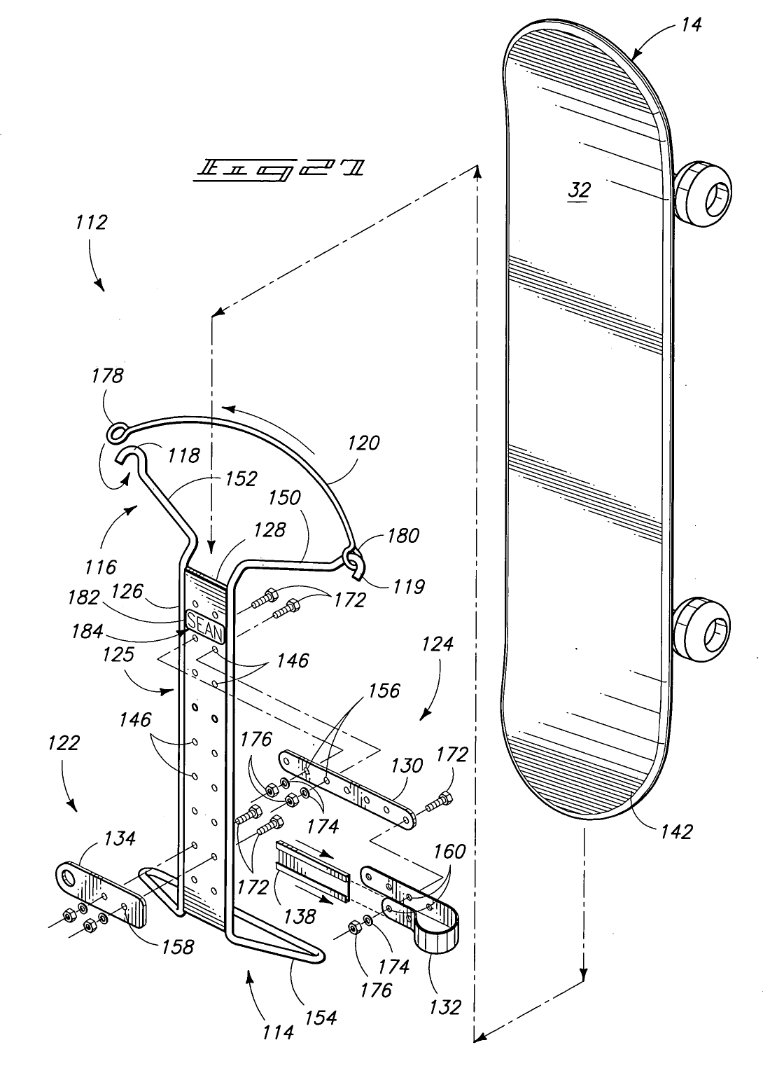

FIG. 25 illustrates one construction for fastener 136. More particularly, fastener 136 is provided by a bolt 172, washer 174, and nut 176. However, it is understood that other fasteners could be used, such as screws, rivets, and even welds.

FIG. 26 shows elastic cord 120 in an unstretched state. Cord 120 has a loop 178 and 180 formed in each respective end. Loops 178 and 180 can be formed by sewing, tying, welding, or using hogs (or fasteners) that secure elastic cord onto itself.

FIG. 27 illustrates skateboard carrying apparatus 112 of FIGS. 2-9 in a partially exploded view and in relation to a skateboard 14 that is vertically retained for carrying apparatus 112.

Although apparatus 112 has been shown in a configuration for carrying a skateboard 14, it is understood that apparatus 112 can be modified in size and geometry in order to carry any of a number of sport boards, such as wakeboards, snowboards, skim boards, surf boards, and boogie boards on a bicycle frame.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. An apparatus for carrying a board on a bicycle, comprising:
a board rack carried by a frame of the bicycle and having a vertical receiver adjacent a bottom end and a quick release retainer above the vertical receiver, the vertical receiver configured to removably receive and support a bottom end of a board and the quick release retainer configured to releasably retain the board to the rack; and
at least one pitch-adjustable mounting bracket carried by the frame and configured to affix the frame onto a bicycle fork.

2. The apparatus of claim 1, wherein the at least one mounting bracket comprises an upper mount supported by the frame at one of a plurality of specific vertical locations and a lower mount supported by the frame beneath the upper mount.

3. The apparatus of claim 2, wherein the upper mount comprises a frame collar pivotally affixed onto one of a plurality of specific horizontal locations on the mounting bracket and configured to mount onto a bicycle frame fork having a specific rake angle to accommodate such angle and the lower mount comprises a mounting plate having an aperture for receiving a bicycle wheel axle to rigidly affix the mounting plate onto the wheel axle with a bicycle wheel quick release nut.

4. The apparatus of claim 3, wherein the upper mount further comprises a mounting plate affixed along one end to the frame and affixed along an opposite end to the frame collar, and further comprising a resilient and frictionable interface cover provided along an inner surface of the frame collar to provide a frictionable interface between the frame collar and the bicycle frame fork.

5. The apparatus of claim 3, wherein the upper mount and the lower mount are provided in a first substantially vertical plane and the vertical receiver and the quick release retainer are provided in a second substantially vertical plane spaced laterally of the first plane.

6. The apparatus of claim 5, wherein the board rack comprises a rectangular frame plate and a wire cage affixed onto the frame plate.

7. The apparatus of claim 6, wherein the frame plate includes a display surface on which user-identifiable indicia are provided in a visually perceptible location.

8. The apparatus of claim 6, wherein the frame plate comprises a rectangular piece of diamond plate.

9. The apparatus of claim 6, wherein the wire cage comprises a pair of diverging arms along a top end, each terminating in a hook, and a hoop provided at a bottom end, wherein the hoop cooperates with a bottom end of the frame plate to provide the vertical receiver.

10. The apparatus of claim 9, wherein the quick release retainer comprises the pair of diverging arms, the respective hooks, and an elastic cord with a loop at each end extending between the pair of hooks.

11. A skateboard carrying apparatus for a bicycle, comprising:
a skateboard rack having a vertical receiver adjacent a bottom end configured to receive and support a tapering heel of a skateboard and a quick release retainer above the vertical receiver, the vertical receiver configured to removably receive and support a bottom end of a board and the quick release retainer configured to releasably retain the board to the rack; and
at least one rake-adjustable mounting bracket carried by the frame and configured to affix the frame onto a bicycle fork.

12. The skateboard carrying apparatus of claim 11, wherein the rack comprises a base plate and a wire cage.

13. The skateboard carrying apparatus of claim 12, wherein the wire cage comprises a hoop along a bottom end and a pair of diverging arms along a top end, with each arm providing a respective hook.

14. The skateboard carrying apparatus of claim 13, further comprising an elastic cord configured to extend between the hooks, wherein the arms, hooks, and elastic cord cooperate to provide the quick release retainer.

15. The skateboard carrying apparatus of claim 11, wherein the at least one mounting bracket comprises a lower mount configured to mate with an axle and quick release hub of a front bicycle wheel and an upper mount affixed to the frame at a selected one of a plurality of vertical locations along the frame having a rotationally adjustable clamp collar affixed onto a selected one of a plurality of horizontal locations along a mounting plate of the upper frame and configured to mate with a tube of a bicycle front fork to accommodate one of a rake angle of the bicycle front fork and a desired rake angle of the skateboard rack.

16. A board rack for a bicycle, comprising:
a wire frame having a vertical receiver along a bottom end and a quick release retainer along a top end;
a frame plate affixed to the wire frame;
an upper mount affixed to the frame plate having a releasable clamp pivotally affixed to the upper mount for placement at a desired angular position for securing around a frame fork of a bicycle; and
a lower mount affixed to the frame plate beneath the upper mount and having a mounting plate with an aperture configured to be affixed onto a wheel axle on the frame fork with a quick release wheel lock assembly.

17. The board rack of claim 16, wherein the wire frame comprises a hoop provided along a lower end and a pair of diverging arms provided along an upper end.

18. The board rack of claim 16, wherein the frame plate comprises a rectangular piece of sheet metal having an array of apertures provided along varying vertical locations on the frame plate and configured to mount the upper mount and the lower mount at selected locations along the frame plate.

19. The board rack of claim 18, further comprising at least one fastener received within at least one of the apertures and configured to affix the upper mount to the frame plate and at least one fastener configured to affix the lower mount to the frame plate to mount the board rack relative to the frame fork of a bicycle with a desired rake.

20. The board rack of claim 16, wherein the frame plate includes a surface and visually-perceptible indicia provided on the surface for identifying one of: a) an owner; b) a manufacturer; and c) an advertiser.
